(19) United States
(12) Patent Application Publication
(10) Pub. No.: US 2006/0113043 A1
(43) Pub. Date: Jun. 1, 2006

(54) Adhesive binding tape cutter

(75) Inventor: Toshiaki Imazeki, Chiba-ken (JP)

Correspondence Address: GREENBLUM & BERNSTEIN, P.L.C., 1950 ROLAND CLARKE PLACE, RESTON, VA, 20191, US

(73) Assignee: CPC Co., Ltd., Chiba (JP)

(21) Appl. No.: 10/999,149

(22) Filed: Nov. 30, 2004

(30) Foreign Application Priority Data
Nov. 29, 2004 (JP) 2004-343344

(51) Int. Cl. B29C 65/00; B65B 11/00

(52) U.S. Cl. 156/522; 156/443; 53/203; 83/78

(57) ABSTRACT

The present invention provides an adhesive binding tape cutter capable of automatically forming a tab that makes it easy to peel off an adhesive tape when the adhesive tape is used to bind an object. An adhesive binding tape cutter 1 comprises: a tape-supporting member for supporting an wound body of adhesive tape 13 in a rotatable manner; a guide-path 15 for connecting an inlet 16 and an outlet 17 for object W; a tape-supplying member 29 for guiding an adhesive tape 12 drawn from the wound body of adhesive tape 13 into the guide-path 15 and for surrounding object W with the adhesive tape 12; and a tape-cutting member 34 that is located behind the tape-supplying member 29 in the guide-path 15 and protrudes so that the tape-cutting member 29 can enter into the guide-path 15; wherein an overlapping-area-forming mechanism 20 for forming an overlapping area 12C by folding under a margin 12E of the adhesive tape 12 in a specified width toward its adhesive surface 12A side is placed between the tape-supporting member and the guide-path 15.

### BACKGROUND

The present invention relates to an adhesive binding tape cutter for automatically binding, with an adhesive tape, an object to be bound, such as the top of a bag or a plurality of bar-shaped products, at a ‘binding’ location on the object.

In the past, adhesive tape has been made by applying an adhesive agent containing rubber or synthetic resin as its principal component, onto one side of a long thin-film base material of, for example, cloth, cellophane, kraft paper, rubber, or polyvinyl chloride. This kind of adhesive tape is wound into a roll and is generally distributed as a wound body of adhesive tape. The adhesive tape is used for various adhesion purposes.

Various kinds of adhesive binding tape cutters are known for automatically binding, with the above-described adhesive tape, an object such as the top of a bag or a plurality of bar-shaped products. As an example of this type of adhesive binding tape cutter, there is a known tape cutter that comprises: a holding member for holding an wound body of an adhesive tape in a rotatable manner; a guide-path for guiding the object; a tape-supplying member that guides the adhesive tape drawn from the wound body of adhesive tape into the guide-path and has a recess for surrounding the object with the adhesive tape; and a tape cutter that is located behind and below the tape-supplying member in the guide-path and protrudes so that the tape cutter can enter into the guide-path.

By using the adhesive binding tape cutter structured as described above, and by setting, on the tape-supplying member, the adhesive tape drawn from the wound body of adhesive tape held by the holding member and then inserting the object via an inlet into the guide-path, the object is guided to the recess of the tape-supplying member. At the same time, after the periphery of the object is surrounded with the adhesive tape, the adhesive tape can be stuck down and seal the object in a bound and fastened state. Moreover, after the adhesive tape stuck to the object, which has been moved downstream of the guide-path, is cut by the tape cutter at a position closer to the wound body of adhesive tape, it is possible to take the object out from the guide-path. If it is necessary to cut the top end of the bound object, for example, the top end of a bag, a cutter mounted on the side of the guide-path is used to cut it. (For example, see Japanese Utility Model (Kokoku) Publication No. SHO 44-14958, Japanese Utility Model (Kokoku) Publication No. SHO 61-40655, and Japanese Utility Model (Kokoku) Publication No. SHO 62-21534.)

In order for a user to avoid the risk of touching the cutter with his/her finger while working to bind the object, using the adhesive binding tape cutter, there is also another type of adhesive binding tape cutter that enables safe binding work by preventing finger contact with the cutter used for cutting the top end of the object. This adhesive binding tape cutter facilitates binding work for objects of different sizes, makes it possible to improve the adhesion of the adhesive tape, and has a structure that makes it easy to carry a binding seal apparatus. (For example, see Japanese Patent Laid-Open (Kokai) Publication No. HEI 11-91730.)

However, the adhesive tape used in a conventional adhesive binding tape cutter is often used for the purpose of temporary binding, for example, where the adhesive tape is used to automatically bind the object, such as the top of a bag or a plurality of bar-shaped products, at a ‘binding’ location on the object and then the binding is removed afterwards. In this case, the adhesive tape is either torn or cut off at the ‘binding’ location.

Since the adhesive tape used with the adhesive binding tape cutter to bind the object is made by applying an adhesive agent over one entire side of a thin base material, it is difficult and cumbersome to peel the adhesive tape off the object. Specifically speaking, in order to peel off adhesive tape where the entire adhesive surface is stuck to the object, it is necessary, for example, to form a tab by scratching the adhesive tape with finger nails or the like to cause the end of the adhesive tape to stick up, and to pull the tab to peel off the adhesive tape. This process of scratching and forming a tab is cumbersome and burdensome. If the entire surface of the adhesive tape is stuck down, it is even more difficult to peel it off. Accordingly, scissors or cutter knives are generally used to cut off the top of a bag in order to open the bound top of the bag. Also, in order to remove the binding of bound bar-shaped products etc., scissors or cutter knives are generally used to cut off the binding tape, paying attention not to damage the bar-shaped products etc.

### SUMMARY

The present invention aims to improve the conventional adhesive binding tape cutter described above. It is the object of this invention to provide an adhesive binding tape cutter capable of, when binding the object with the adhesive tape, automatically forming a tab that makes it easier to peel off the adhesive tape.

In order to achieve the above-described object, this invention provides an adhesive binding tape cutter for binding an object with adhesive tape, comprising: a tape-supporting member for supporting an wound body of adhesive tape in a rotatable manner around which a tape whose one side is an adhesive surface is wound; a guide-path for connecting an inlet and an outlet for the object; a tape-supplying member for guiding the adhesive tape drawn from the wound body of adhesive tape into the guide-path and for surrounding the object with the adhesive tape; and a tape-cutting member that is located behind the tape-supplying member in the guide-path and protrudes so that the tape-cutting member can enter into the guide-path; wherein an overlapping-area forming mechanism for forming an overlapping area of the adhesive tape, along at least one margin in its lengthwise direction, made by folding under a specified width of the adhesive tape toward the adhesive surface side is placed between the tape-supporting member and the guide-path, and wherein the overlapping-area forming mechanism comprises: a first support member that is located near an adhesive-tape-unwinding position of the wound body of adhesive tape and supports a non-adhesive surface of the adhesive tape; a fold-starting member that is located downstream of the first support member, supports the adhesive surface of the adhesive tape while leaving a specified folding width along the margin of the adhesive tape, and folds the folding width area; a main folding member that is located downstream of the fold-starting member and folds under, at an acute angle, the area of the adhesive tape folded by the fold-starting member; and an attaching member that is located at a position opposite the main folding member, supports the non-adhesive surface of the adhesive tape, and presses and attaches the area folded by the main folding member to the adhesive surface of the adhesive tape.

In the adhesive binding tape cutter having the above-described structure, the fold-starting member supports (or is in contact with) the adhesive surface of the adhesive tape when the overlapping area is formed on the adhesive tape drawn from the wound body of adhesive tape supported by the tape-supporting member in a rotatable manner. Since this adhesive binding tape cutter has no member (such as a roller) for pressing the adhesive tape hard against the fold-starting member, at a position on the other side of the adhesive tape opposite the fold-starting member, the adhesive tape is guided downstream without having the adhesive surface of the adhesive tape stuck fast to the surface of the fold-starting member. Moreover, the non-adhesive surface of the adhesive tape is in contact with the first support member and the attaching member. Accordingly, little power is required in order to draw the adhesive tape from the wound body of adhesive tape, thereby making it possible to unwind the adhesive tape smoothly.

The adhesive binding tape cutter of this invention can further comprise a second support member that is located downstream of the attaching member and supports the non-adhesive surface of the adhesive tape. In addition to the above-described advantageous effect, the existence of the second support member makes it possible to make the adhesive tape reach the tape-supplying member in a more stable condition.

Moreover, in the adhesive binding tape cutter of this invention, protrusions and indentations can be formed on the surface of the fold-starting member. This structure makes it possible to further reduce the area (contact area) of the surface of the fold-starting member with which the adhesive surface of the adhesive tape comes into contact.

The first support member, the fold-starting member, and the attaching member can be composed of roller members placed in a rotatable manner so that they guide the adhesive tape from upstream to downstream. The second support member can also be composed of a roller member placed in a rotatable manner so that it guides the adhesive tape from upstream to downstream.

In the adhesive binding tape cutter of this invention, a controlling member for controlling the position of the adhesive tape can be placed at the end of the fold-starting member on the side where the other margin of the adhesive tape is located, opposite the margin where the overlapping area of the adhesive tape is formed. The existence of the controlling member makes it possible to fold the adhesive tape in a more stable manner and with more certainty.

Moreover, the adhesive binding tape cutter of this invention can be formed so as to make a distance between the controlling member of the fold-starting member and the contact part of the main folding member that comes into contact with the margin side of the overlapping area of the adhesive tape shorter than the adhesive tape width of the wound body of adhesive tape. This structure also makes it possible to fold the adhesive tape in a more stable manner and with more certainty.

Furthermore, in the adhesive binding tape cutter of this invention, a controlling member for controlling the position of the adhesive tape can be placed at the end of the second support member on the side where the other margin of the adhesive tape is located, opposite the margin where the overlapping area of the adhesive tape is formed. This structure also makes it possible to fold the adhesive tape in a more stable manner and with more certainty.

Also, the adhesive binding tape cutter of this invention can be formed so as to make the distance between the controlling member of the second support member and the contact part of the main folding member that comes into contact with the margin side of the overlapping area of the adhesive tape shorter than the adhesive tape width of the wound body of adhesive tape. This structure also makes it possible to fold the adhesive tape in a more stable manner and with more certainty.

The main folding member can have a pressing member capable of pressing only the vicinity of the area of the adhesive tape folded under by the main folding member. Because of this fold-starting member structure, it is possible to reduce the area of the main folding member that comes into contact with the adhesive surface of the adhesive tape. Accordingly, much less power is required to draw the adhesive tape from the wound body of adhesive tape, thereby making it possible to unwind the adhesive tape more smoothly.

Moreover, the main folding member can comprise: a first folding guide member that comes into contact with the non-adhesive surface of the adhesive tape folded by the fold-starting member and guides the adhesive tape so that the fold angle of the adhesive tape becomes more acute; and a second folding guide member for guiding the adhesive tape and folding the adhesive tape completely onto itself. Because of this structure of the main folding member, it is possible to fold the adhesive tape under in a more stable manner and with more certainty.

The adhesive binding tape cutter of this invention can be structured in a manner such that the tape-supplying member has a number of radially extending projections and can rotate in order to guide the adhesive tape from upstream to downstream, wherein the projections are located within the guide-path and engage with the object guided into the guide-path, thereby making the tape-supplying member rotate.

Moreover, the adhesive binding tape cutter of this invention can further comprise an affixing member that is located at a position opposite to the top ends of the projections of the tape-supplying member and has a bent sliding surface that slides in a manner capable of moving closer to and away from the tape-supply member and comes into contact with the top ends of the projections of the tape-supplying member as it slides, wherein the sliding surface causes affixing of a specified length of the adhesive surface of the adhesive tape.

The adhesive binding tape cutter of this invention can be structured in a manner such that the affixing member is provided with a force-applying member for applying force to the affixing member in order to make the affixing member press and come into contact with the top ends of the projections of the tape-supplying member.

Moreover, the adhesive binding tape cutter of this invention can be structured in a manner such that the tape-cutting member is located downstream of the tape-supplying member, is capable of rotating on the axis of its approximate center, and has force applied to its lower end so that the tape-cutting member is always located within the guide-path, and has a cutting blade at its upper end; wherein when an object guided into the guide-path presses on the lower end and causes the tape-cutting member to rotate, the cutting blade placed at the upper end of the tape-cutting member moves into the guide-path and cuts the adhesive tape.

This invention also provides an adhesive tape for the above-described adhesive binding tape cutter of this invention, wherein a marked line is formed along the overlapping area in the vicinity of an area to become the overlapping area formed by the overlapping-area-forming mechanism of the adhesive binding tape cutter.

With the adhesive tape having the above-described structure, for the adhesive binding tape cutter, it is possible to use the marked line to indicate the position of the overlapping area when binding the object. Accordingly, when a user intends to remove the binding of the object, he/she can easily look at the tab (i.e. the overlapping area) for peeling off the adhesive tape and can thereby remove the binding more easily.

Moreover, the marked line can include at least one of: marks, letters, and pictures to indicate the existence of the overlapping area.

Therefore, when the overlapping area is formed on the adhesive tape drawn from the wound body of adhesive tape supported by the tape-supporting member in a manner such that the wound body of adhesive tape can rotate, the adhesive binding tape cutter of this invention makes it possible to draw the adhesive tape from the wound body of adhesive tape with little power, and without having the adhesive surface of the adhesive tape firmly attach to the surfaces of the components that constitute the overlapping-area-forming mechanism. As a result, it is possible to unwind the adhesive tape smoothly and to improve workability in binding an object with the adhesive tape.

### DESCRIPTION OF DRAWINGS

FIG. 1 is a perspective view of the adhesive binding tape cutter according to a preferred embodiment of this invention.

FIG. 2 is a front view of the adhesive binding tape cutter of FIG. 1.

FIG. 3 is a plan view of the adhesive binding tape cutter of FIG. 2, from which the wound body of adhesive tape is removed.

FIG. 4 is a sectional view of the adhesive binding tape cutter taken along line IV-IV of FIG. 3.

FIG. 5 is a right side view of the adhesive binding tape cutter of FIG. 2.

FIG. 6 is a left side view of the adhesive binding tape cutter of FIG. 2.

FIG. 7 is an exploded perspective view of the adhesive binding tape cutter of FIG. 2, in which the wound body of adhesive tape is omitted.

FIG. 8 shows the state in which the wound body of adhesive tape that is rotatable and supported by the tape-supporting member is attached to the adhesive binding tape cutter of FIG. 4.

FIG. 9 shows the state in which the adhesive tape is caused to pass through the adhesive tape cutter of FIG. 3.

FIG. 10 explains a part of the binding process of the adhesive binding tape cutter according to the embodiment of this invention.

FIG. 11 explains a part of the binding process of the adhesive binding tape cutter according to the embodiment.

FIG. 12 explains a part of the binding process of the adhesive binding tape cutter according to the embodiment.

FIG. 13 explains a part of the binding process of the adhesive binding tape cutter according to the embodiment.

FIG. 14 explains a part of the binding process of the adhesive binding tape cutter according to the embodiment.

FIG. 15 explains a part of the binding process of the adhesive binding tape cutter according to the embodiment.

FIG. 16 explains a part of the binding process of the adhesive binding tape cutter according to the embodiment.

FIG. 17 explains a part of the binding process of the adhesive binding tape cutter according to the embodiment.

FIG. 18 explains a part of the binding process of the adhesive binding tape cutter according to the embodiment.

FIG. 19 explains a part of the binding process of the adhesive binding tape cutter according to the embodiment.

FIG. 20 explains a part of the binding process of the adhesive binding tape cutter according to the embodiment.

FIG. 21 explains a part of the binding process of the adhesive binding tape cutter according to the embodiment.

FIG. 22 is a perspective view of an object bound by the adhesive binding tape cutter according to the embodiment.

FIG. 23 is a fragmentary plan view of the adhesive tape used for the adhesive binding tape cutter according to the embodiment.

### DETAILED DESCRIPTION

The adhesive binding tape cutter according to a preferred embodiment of this invention is described below with reference to the attached drawings.

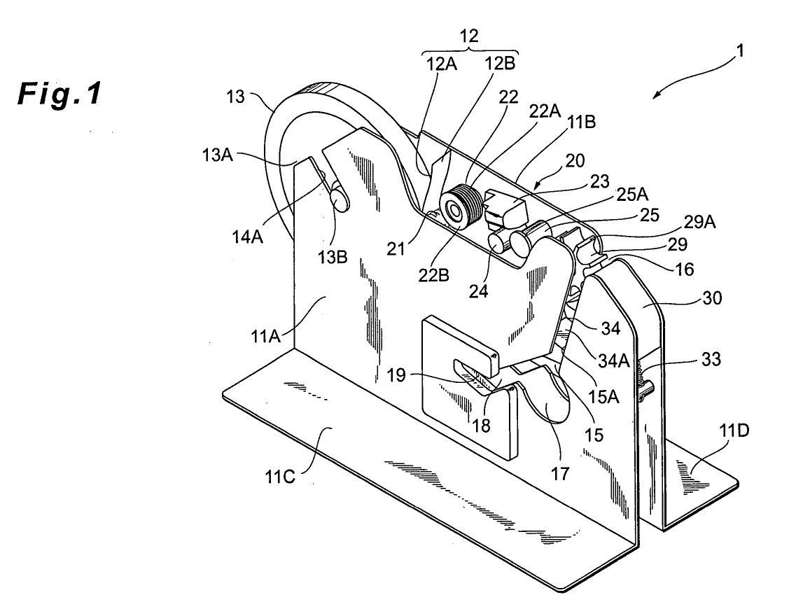

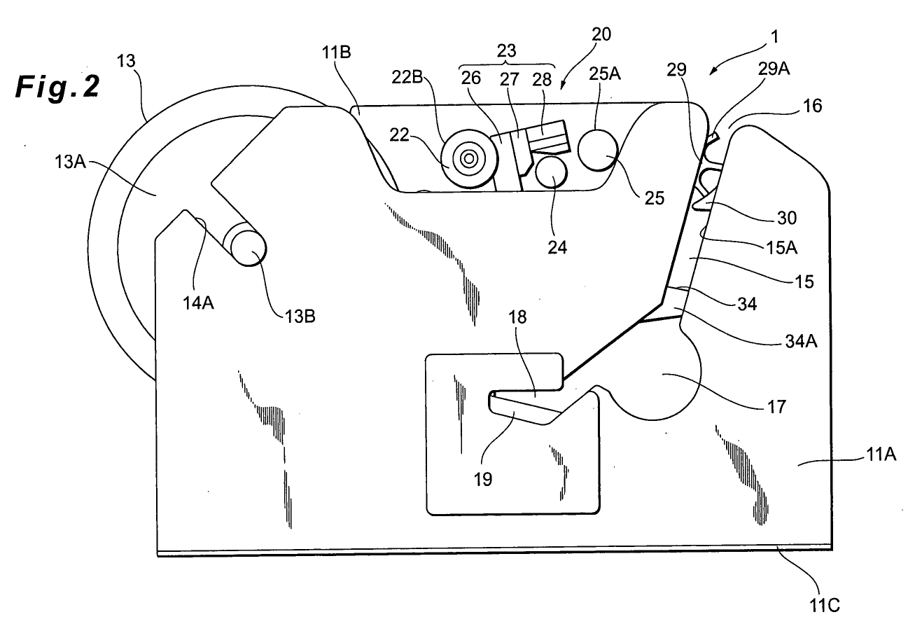

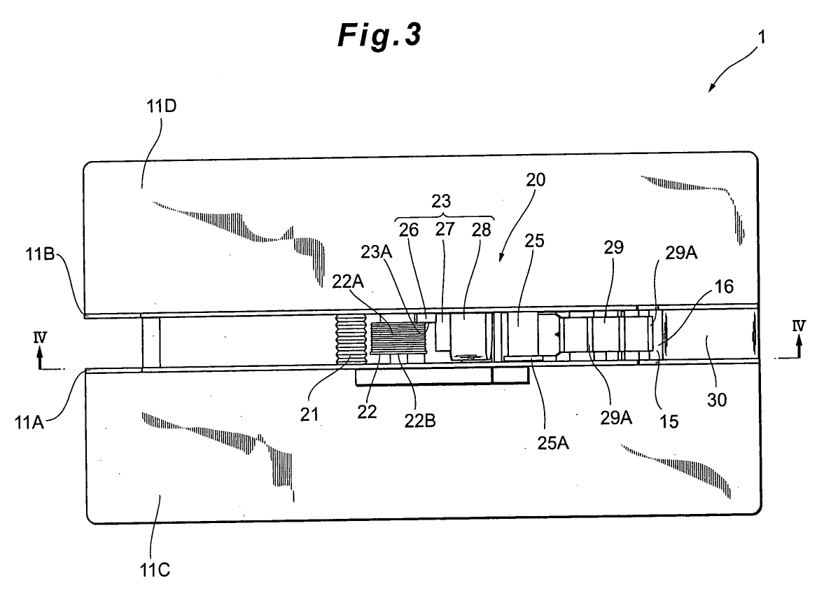

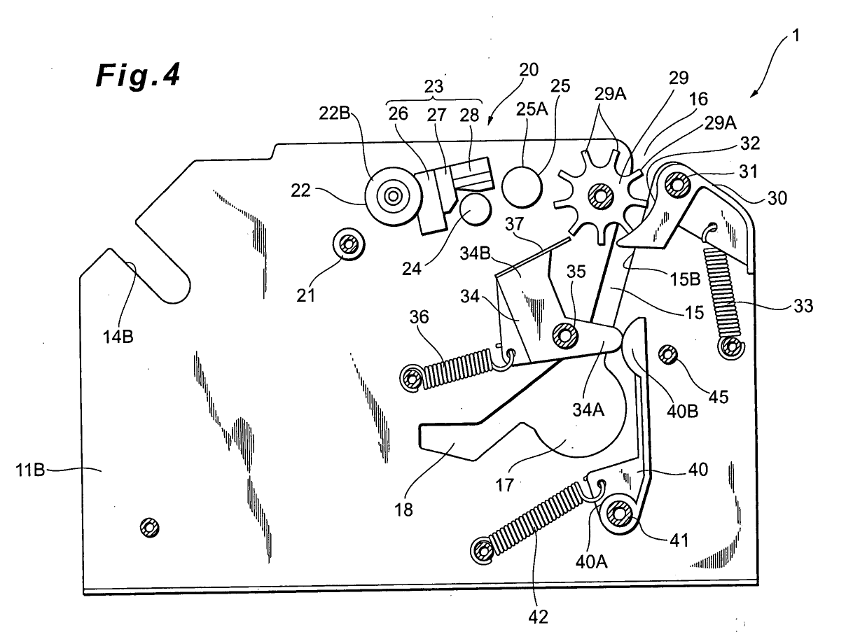

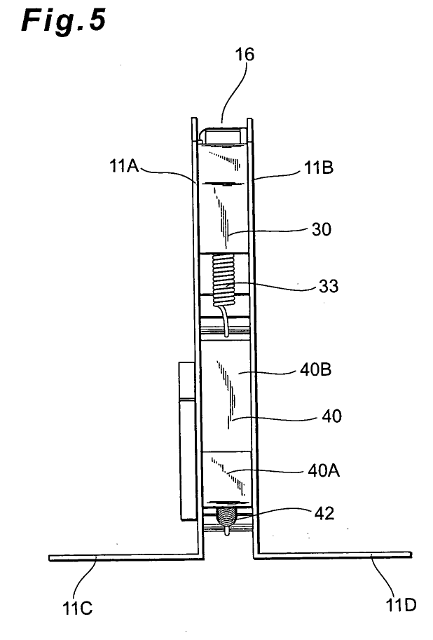

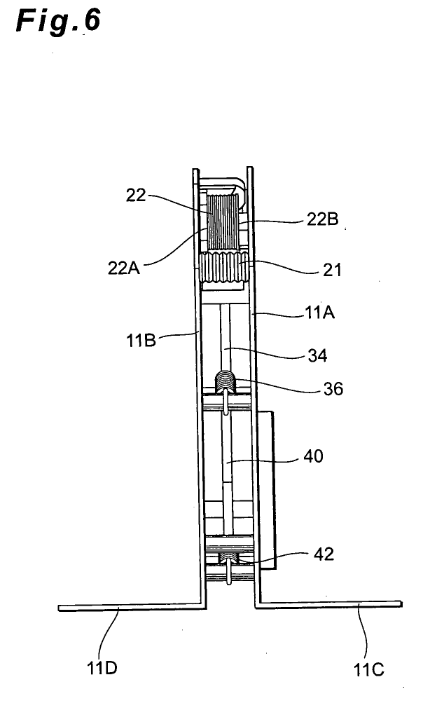

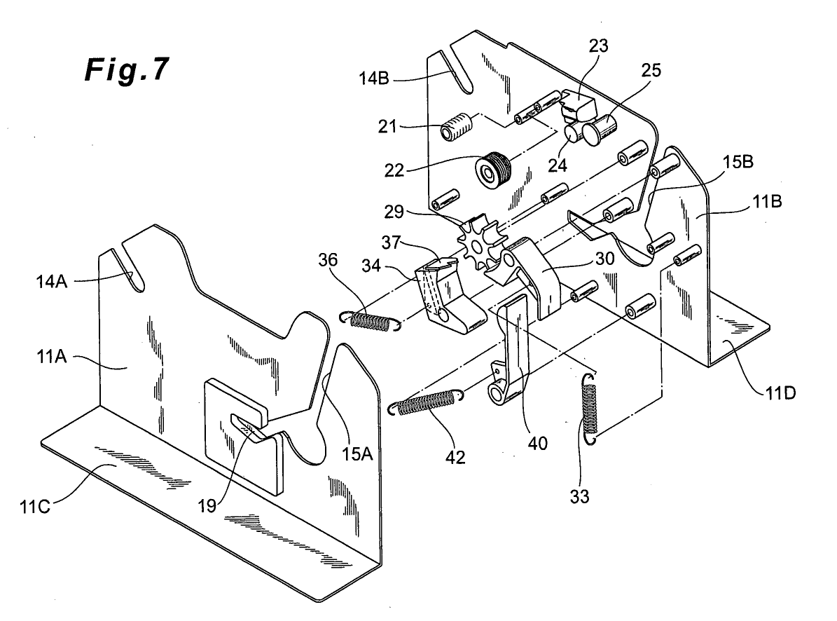

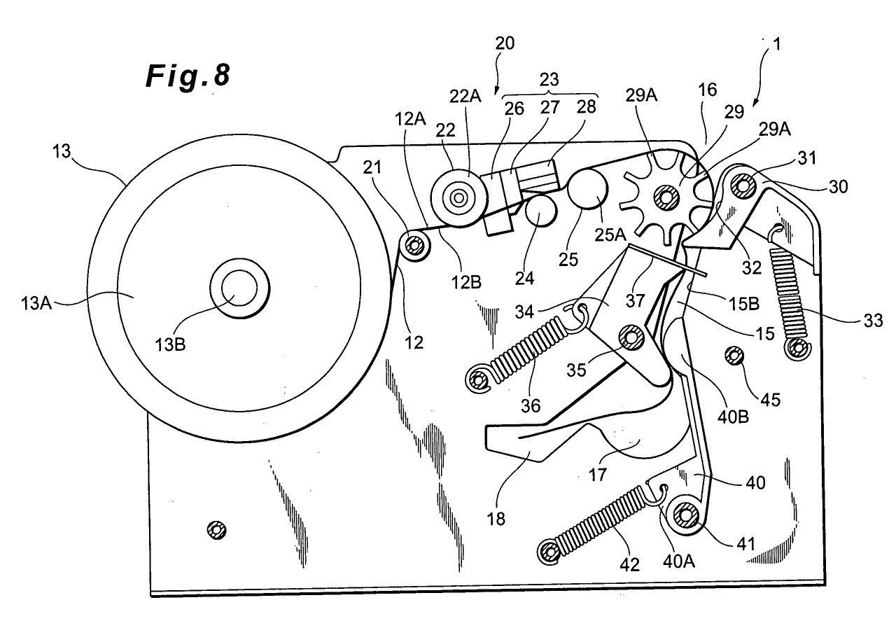

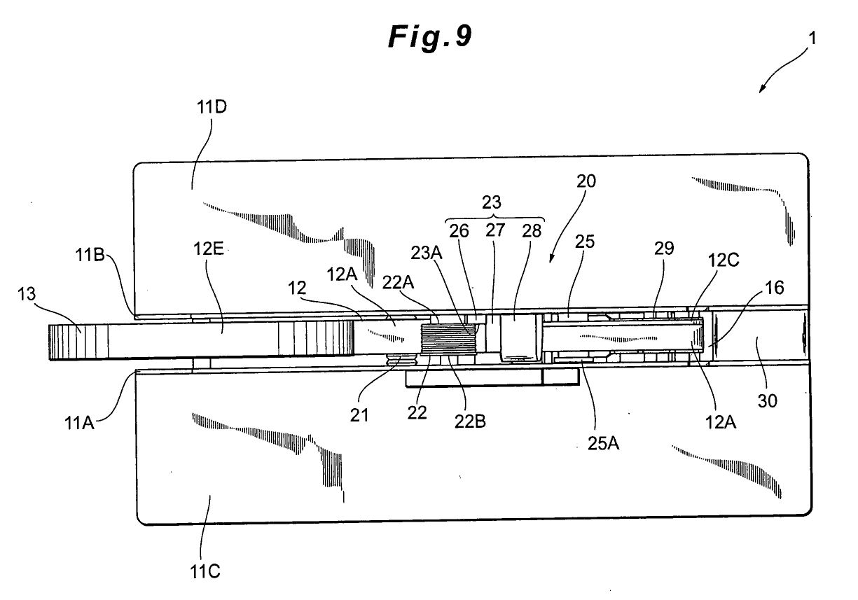

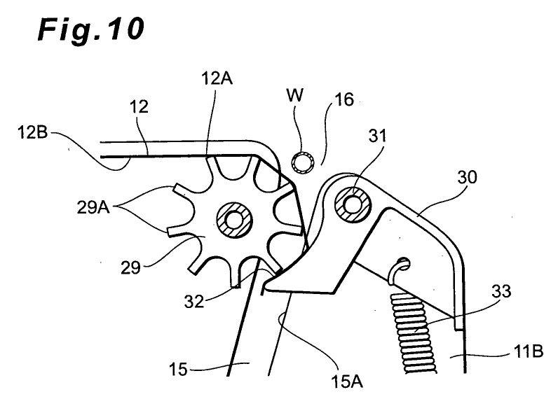

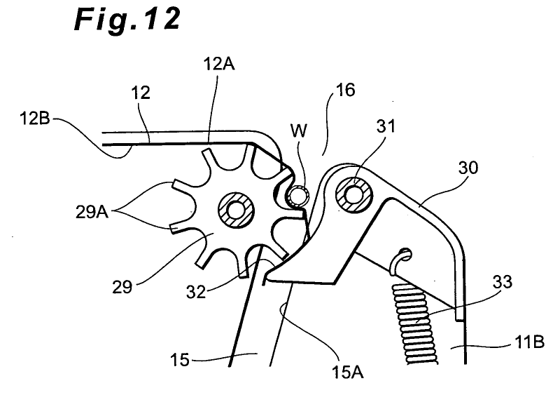

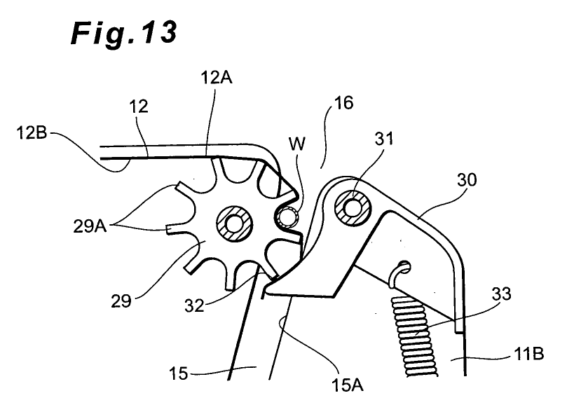

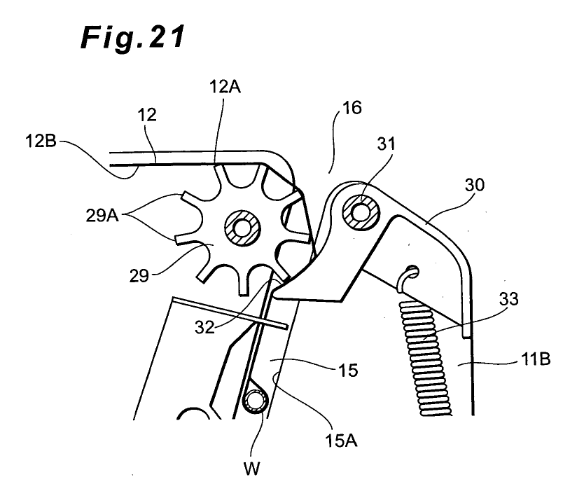

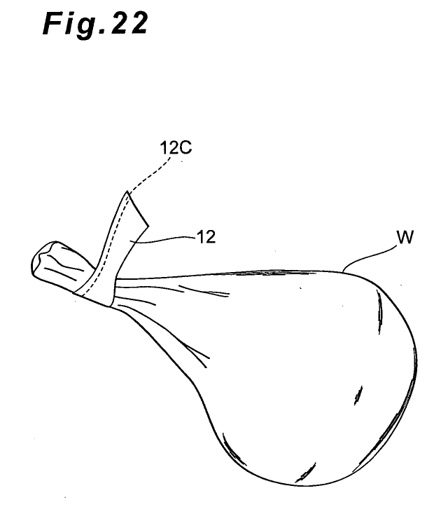

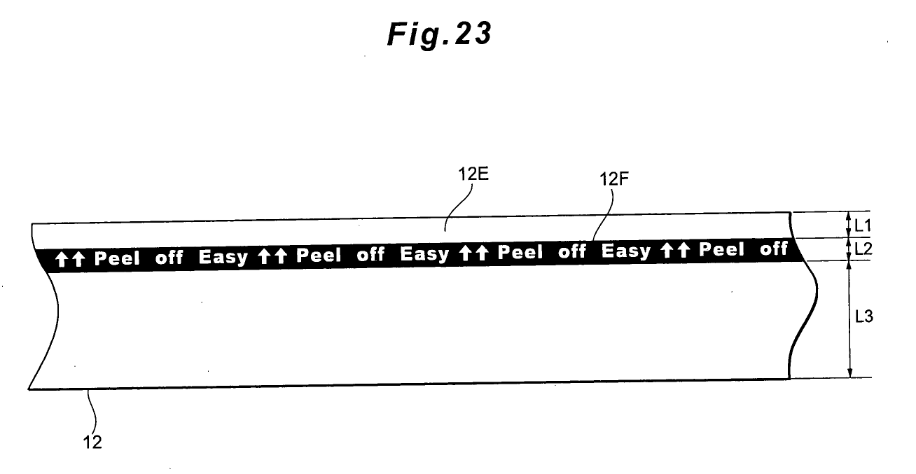

FIG. 1 is a perspective view of the adhesive binding tape cutter according to a preferred embodiment of this invention. FIG. 2 is a front view of the adhesive binding tape cutter of FIG. 1. FIG. 3 is a plan view of the adhesive binding tape cutter of FIG. 2, from which the wound body of adhesive tape is removed. FIG. 4 is a sectional view of the adhesive binding tape cutter taken along line IV-IV of FIG. 3. FIG. 5 is a right side view of the adhesive binding tape cutter of FIG. 2. FIG. 6 is a left side view of the adhesive binding tape cutter of FIG. 2. FIG. 7 is an exploded perspective view of the adhesive binding tape cutter of FIG. 2, in which the wound body of adhesive tape is omitted. FIG. 8 shows the state in which the wound body of adhesive tape that is rotatable and supported by the tape-supporting member is attached to the adhesive binding tape cutter of FIG. 4. FIG. 9 shows the state in which the adhesive tape is caused to pass through the adhesive tape cutter of FIG. 3. FIGS. 10 to 21 explain step-by-step the binding process of the adhesive binding tape cutter according to the embodiment of this invention. FIG. 22 is a perspective view of an object bound by the adhesive binding tape cutter according to the embodiment. FIG. 23 is a fragmentary plan view of the adhesive tape used for the adhesive binding tape cutter according to the embodiment.

As shown in FIGS. 1 to 22, an adhesive binding tape cutter 1 according to this embodiment comprises support plates 11A and 11B that are located opposite each other with a certain distance between them. These support plates 11A and 11B serve as a housing for the adhesive binding tape cutter 1. Cutouts 14A and 14B for supporting, in a rotatable manner, a shaft 13B of a roll core 13A around which an adhesive tape 12 is wound in a roll are formed respectively in the upstream area (on the left side in FIG. 2) of the support plates 11A and 11B. These cutouts 14A and 14B constitute a tape-supporting member for supporting an adhesive-tape-wound body 13 in a rotatable manner as described below in detail.

The adhesive-tape-wound body is formed by winding, in a roll around the roll core 13A, the adhesive tape 12 whose one side is an adhesive surface 12A and whose other side is a non-adhesive surface 12B.

As shown in FIG. 23, the adhesive tape 12 has a continuous marked line 12F of width L₂ running in the lengthwise direction of the adhesive tape 12 at a position distance L₁ from one edge of the adhesive tape 12. An area extending from one edge of the adhesive tape 12 to the mark line 12F (an area of distance L₁) is margin 12E of the adhesive tape 12. The words “Peel off Easy” are indicated on this marked line 12F. Reference numeral L₃ in FIG. 23 indicates the distance from the marked line 12F to the other edge of the adhesive tape 12 opposite to the above-mentioned margin 12E.

When the adhesive binding tape cutter 1 according to this embodiment, described later in detail, folds the margin 12E of this adhesive tape 12 to form an overlapping area 12C (see FIG. 9), the marked line 12F becomes adjacent to the overlapping area 12C.

Cutouts 15A and 15B that are open downwards from the top of the tape cutter 1 are formed downstream of the support plates 11A and 11B (on the right side in FIG. 2). The space formed between these cutouts 15A and 15B and the support plates 11A and 11B constitutes a guide-path 15 through which object W passes. The top end of this guide-path 15 is an inlet 16 for object W, while its bottom end is an outlet 17 from which object W is removed. A guide groove 18 extending laterally is formed behind the outlet 17. At the lower part of this guide groove 18, a cutter 19 is mounted for cutting the top of object W. The bottom ends of the support plates 11C and 11D are formed as legs 11C and 11D that are respectively bent outward at an approximately 90-degree angle.

The top of the support plate 11A between the cutout 14A and the cutout 15A is cut out and made concave downward where an overlapping-area-forming mechanism 20 is placed. This overlapping-area-forming mechanism 20 comprises: a first supporting roll 21 that is rotatable and placed in a rotatable manner near an adhesive-tape-unwinding position of the adhesive-tape-wound body 13 and supports the non-adhesive surface 12B of the adhesive tape 12; a fold-starting roll 22 that is rotatable and located downstream of the first support roll 21, supports the adhesive surface 12A of the adhesive tape 12 except for a certain folding width along the margin of the adhesive tape 12, and folds the folding width of the margin 12E of the adhesive tape 12 closest to the support plate 11B (see FIG. 9); a main folding member 23 that is located downstream of the fold-starting roll 22 and folds under, at an acute angle, the area of the adhesive tape 12 folded by the fold-starting roll 22; an attaching roll 24 that is rotatable and placed in a rotatable manner at a position opposite the main folding member 23, supports the non-adhesive surface 12B of the adhesive tape 12, and presses and attaches the margin 12E folded under by the main folding member 23 to the adhesive surface 12A of the adhesive tape 12; and a second support roll 25 that is placed in a rotatable manner downstream of the attaching roll 24 and supports the non-adhesive surface 12B of the adhesive tape 12.

The first support roll 21 is cylindrical in shape and both its ends are attached in a rotatable manner to the support plates 11A and 11B.

The fold-starting roll 22 is shaped like a cylinder, having a larger diameter than that of the first support roll 21, and one end of the fold-starting roll 22 on the side of the support plate 11B is attached in a rotatable manner to the support plate 11B. Pluralities of grooves 22A are formed around the circumferential surface of the fold-starting roll 22. Moreover, a flange 22B is formed at the end of the fold-starting roll 22 closer to the support plate 11A. The distance between this flange 22B and a contact part 23A (see FIG. 3) of a main folding member 23 described later in detail that comes into contact with the margin of the adhesive tape 12 where an overlapping area 12C (see FIG. 9) is to be formed, is set to be shorter than the width of the adhesive tape 12. Therefore, the flange 22B plays the role of a controlling member for controlling the position of the adhesive tape 12.

The main folding member 23 comprises the following components listed in order from upstream to downstream: a fold-angle-maintaining member 26 that comes into contact with the non-adhesive surface 12B of the margin 12E of the adhesive tape 12 and keeps the fold angle of the margin 12E; a first folding guide member 27 that is connected to the fold-angle-maintaining member 26 and guides the adhesive tape 12 so that the fold angle of the margin 12E of the adhesive tape 12 becomes approximately 120 degrees, that is, the fold angle on the adhesive surface 12A side becomes an acute angle of approximately 60 degrees; and a second folding guide member 28 that is connected to the first folding guide member 27 and comes into contact with and folds the non-adhesive surface 12B of the margin 12E of the adhesive tape 12 under, to fold the adhesive tape 12 completely onto itself.

The fold-angle-maintaining member 26 projects from the support plate 11B toward the support plate 11A, and this projection makes it possible to come into contact with the non-adhesive surface 12B of the adhesive tape 12 along the margin 12E.

The first folding guide member 27 is inclined with its top end projecting toward and closer to the support plate 11A than its lower end. The fold angle of the margin 12E of the adhesive tape 12 is determined according to this inclination angle. (As stated above, the fold angle in this embodiment is approximately 120 degrees.)

The second folding guide member 28 projects further toward the support plate 11A than the first folding guide member 27 does. The area of the second folding guide member 28 where the folded margin 12E of the adhesive tape 12 closer to the support plate 11B passes is structured to provide a narrow space between the second folding guide member 28 and an attaching roll 24 described below in detail. This narrow space serves to make the second folding guide member 28 come into contact with the non-adhesive surface 12B of the margin 12E of the adhesive tape 12 and fold the margin 12E under, to fold the adhesive tape 12 completely onto itself.

The attaching roll 24 is cylindrical in shape and its end on the support plate 11B side is attached in a rotatable manner to the support plate 11B. This attaching roll 24 is located near, below and opposite the second folding guide member 28 of the main folding member 23, supports the non-adhesive surface 12B of the adhesive tape 12, and presses and attaches the margin 12E of the adhesive tape 12 folded under by the main folding member 23 to the adhesive surface 12A.

A second support roll 25 is cylindrical in shape and its end on the support plate 11B side is attached in a rotatable manner to the support plate 11B. Moreover, a flange 25A is formed at the end of the second support roll 25 on the side of the support plate 11A. The distance between this flange 25A and the contact part 23A (see FIG. 3) of the main folding member 23 that comes into contact with the margin of the adhesive tape 12 where the overlapping area 12C (see FIG. 9) is formed, is set to be shorter than the width of the adhesive tape 12. Therefore, the flange 25A plays the role of a controlling member for controlling the position of the adhesive tape 12.

A tape-supplying member 29 is placed downstream of the overlapping-area-forming mechanism 20, that is, near the inlet 16 of the guide-path for object W. This tape-supplying member 29 is structured so as to guide the adhesive tape 12 drawn from the adhesive-tape-wound body 13 into the guide-path 15 and surround object W with the adhesive tape 12. Specifically speaking, the tape-supplying member 29 is impeller-shaped, having a multiplicity of engaging projections 29A that radially extend at certain intervals, and the tape-supplying member 29 is supported on its axis in a rotatable manner by and between the support plates 11A and 11B.

This tape-supplying member 29 can rotate so as to guide the adhesive tape 12 from upstream to downstream. The engaging projections 29A are positioned within the guide-path 15. As the engaging projections 29A engage with object W guided into the guide-path 15, they cause the tape-supplying member 29 to rotate. In other words, the top ends of the engaging projections 29A engage with and roll object W into the guide-path 15. At the same time, object W pushes and rotates the tape-supplying member 29, while causing the adhesive tape 12 traveling around the top ends of the engaging projections 29A of the tape-supplying member 29 to be pushed into a space between adjacent engaging projections 29A. Tension in the adhesive tape 12 caused by the above-described action causes the adhesive tape 12 with the overlapping area 12C to surround object W and to press and paste the adhesive surfaces 12A together to bind object W.

At a position on the other side of the guide path 15 opposite the tape-supplying means 29, is an affixing member 30 that pastes and affixes the end of the adhesive surface 12A of a specified length of the adhesive tape 12. This affixing member 30 can swing about a spindle 31 as its top part is supported by the spindle 31, which has its ends attached to the support plates 11A and 11B. The affixing member 30 is approximately L shaped and bent at the spindle 31. The side surface of the affixing member 30 opposite to the tape-supplying member 29 is a sliding surface 32 that is bent in a concave manner so as to come into contact with the top end of the engaging projections 29A of the tape-supplying member 29 and to allow rotatory sliding of the engaging projections 29A. This sliding surface 32 is an affixing surface for affixing and engaging the adhesive surfaces 12A of a specified length of the adhesive tape 12.

The curvature of the lower part of the sliding surface 32 is greater than that of its upper part. Accordingly, the lower part of the sliding surface 32 from its approximate middle position comes into contact with the top end of the engaging projection 29A, while the upper part does not come into contact and is positioned away from the engaging projections 29A.

In an area on the other side of the spindle 31 of the affixing member 30 that does not face the tape-supplying member 29, a coil spring 33 is placed to cause the sliding surface 32 of the affixing member 30 to always press and come into contact with the top end of the engaging projection of the tape-supplying member 29, thereby engaging with the adhesive tape 12. The coil spring 33 applies force to the affixing member 30 so that the lower end of the sliding surface 32 projects into the guide-path 15; and when object W is inserted into the guide-path 15 from above and comes into contact with the lower end of the sliding surface 32, the lower end is then pushed back and moved away from the guide-path 15. As described later in detail, once object W is pushed downward below the affixing member 30, the adhesive tape 12 is wound around the part of object W to be bound, thereby binding object W that has moved through the guide-path 15.

Below the tape-supplying member 29 and the affixing member 30, a tape-cutting member 34 is placed in a manner capable of rotating on a spindle 35, which has its ends attached to the support plates 11A and 11B. This tape-cutting member 34 is located on the other side of the guide-path 15, opposite the affixing member 30. The spindle 35 is positioned near the guide-path 15. One end 34A of the tape-cutting member 34 serves as a power point and extends straight into the guide-path 15, while the other end 34B serves as a point of action and bends upward and extends until just below the tape-supplying member 29. Accordingly, the tape-cutting member 34 is bent at the spindle 35 and is in an approximate L shape. Moreover, force is applied to the tape-cutting member 34 by a coil spring 36 in order to cause the power-point lower end 34A to always stay in the guide-path 15. As the power-point end 34A engages with object W inserted and moved downward in the guide-path 15, the tape-cutting member 34 swings. Accordingly, a cutter blade 37 mounted on the action-point upper end 34B enters into the guide-path 15 right below the affixing member 30, thereby cutting off the adhesive tape 12.

In contact with the power-point end 34A of the tape-cutting member 34, a pressing lever 40 for pressing both the cut-off ends of the adhesive tape 12 and thereby securely pasting them together is placed in an always pressed state. The lower end 40A of this pressing lever 40 is supported by a spindle 41 so that the pressing lever 40 can rotate around the spindle 41. A coil spring 42 always applies force to the pressing lever 40 in the direction of the power-point end 34A of the tape-cutting member 34 (counterclockwise in FIG. 4). Therefore, the upper end 40B is pressed against and thereby comes into contact with the end face of the power-point end 34A of the tape-cutting member 34. Reference numeral 45 indicates a stopper for preventing the pressing lever 40 from rotating any further.

Both end faces of the top end 40B of the pressing lever 40 and the power-point end 34A of the tape-cutting member 34 that come into contact with each other are formed as arched surfaces. Therefore, when object W presses down the tape-cutting member 34 and reaches its contact part that comes into contact with the pressing lever 40, the top end 40B of the pressing lever 40 is pushed back and moved away from the power-point end 34A, and object W passes through the space between the tape-cutting member 34 and the pressing lever 40. As object W passes through the space, the adhesive tape 12 wound around the binding part of object W is held between and pressed by the pressing lever 40 and the power-point end 34A so as to firmly join the adhesive surfaces 12A of the adhesive tape 12. Subsequently, the cutter blade 37 of the tape-cutting member 34 cuts off the adhesive tape 12. The adhesive tape 12 that has been cut is pulled out of the space between pressing lever 40 and the power-point end 34A, thereby making the adhesive surfaces 12A firmly and securely pressed and attached together for the entire length of the cut-off adhesive tape 12.

Detailed actions of the adhesive binding tape cutter 1 according to this embodiment are described below.

The shaft 13B is first set in the cutouts 14A and 14B formed in the support plates 11A and 11B so that the adhesive surface 12A of the adhesive tape 12 drawn from the adhesive-tape-wound body 13 faces upward. The adhesive tape 12 is then set as follows: the non-adhesive surface 12B of the adhesive tape 12 is placed on top of the first support roll 21 and the adhesive surface 12A of the adhesive tape 12 goes beneath the fold-starting roll 22; the adhesive tape 12 is then inserted between the main folding member 23 and the attaching roll 24; subsequently, the non-adhesive surface 12B of the adhesive tape 12 goes on top of the second support roll 25; and the adhesive tape 12 finally reaches the tape-supplying member 29.

In order to make the adhesive tape 12 surround and bind the binding part of object W, as shown in FIG. 10, the end of a specified length of the adhesive tape 12 is adhesively attached to the sliding surface 32 of the affixing member 30 and the adhesive tape 12 is placed over and across the top ends of the engaging projections 29A of the tape-supplying member 29 when object W is inserted into the inlet 16 of the guide-path 15.

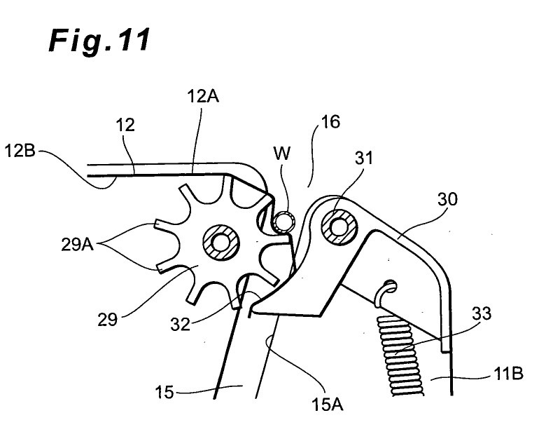

As shown in FIGS. 11 to 13, when object W is inserted and moved downward in the guide-path 15 in the above-described situation, object W enters a concave space formed between adjacent engaging projections 29A and, at the same time, it pushes and rotates the tape-supplying member 29. At the same time, the top end of the engaging projection 29A that comes into contact with object W is not yet in contact with the lower part of the sliding surface 32 of the attaching member 30.

This action causes the adhesive tape 12 to be drawn from the adhesive-tape-wound body 13. At the same time, the adhesive tape 12 is first supported by the first support roll 21 and is then guided toward the area beneath the fold-starting roll 22. At this fold-starting roll 22, its flange 22B engages with the margin of the adhesive tape 12 closer to the support plate 11A and thereby controls the position of the adhesive tape 12. This control causes the margin 12E of the adhesive tape 12 closer to the support plate 11B to become free from the end of the fold-starting roll 22 closer to the support plate 11B. In other words, the fold-starting roll 22 supports the adhesive surface 12A of the adhesive tape 12, leaving a specified folding width along the margin 12E of the adhesive tape 12, and thereby folds the folding width area of the adhesive tape 12.

Subsequently, after the adhesive tape 12 has passed the fold-starting roll 22, the non-adhesive surface 12B of the margin 12E comes into contact with the fold-angle-maintaining member 26 of the main folding member 23. While the fold angle of the margin 12E folded by the fold-starting roll 22 is maintained, the adhesive tape 12 reaches the first folding guide member 27. This first folding guide member 27 further folds the margin 12E of the adhesive tape 12 so as to cause the fold angle of the margin 12E of the adhesive tape 12 to become approximately 120 degrees. The adhesive tape is then inserted between the second folding guide member and the attaching roll 24, thereby folding the margin 12E of the adhesive tape 12 under to fold the adhesive tape 12 completely onto itself, and pasting the adhesive surfaces 12A of this area together to form the overlapping area 12C. Subsequently, the adhesive tape 12 with the overlapping area 12C passes the second support roll 25 and reaches the tape-supplying member 29.

In forming the overlapping area 12C along the margin 12E of the adhesive tape 12, the adhesive surface 12A of the adhesive tape 12 comes into contact with the surface of the fold-starting roll 22. However, because of a plurality of grooves 22A in the surface of the fold-starting roll 22, its contact area with the adhesive surface 12A is small and it is thereby possible to reduce the power necessary to draw the adhesive tape 12 from the adhesive-tape-wound body 13. Moreover, there is no member (such as a roller) pressing the adhesive tape 12 hard against the fold-starting roll 22. Therefore, the adhesive surface 12A of the adhesive tape 12 is not firmly attached to the surface of the fold-starting roll 22, thereby making it possible to unwind the adhesive tape 12 smoothly.

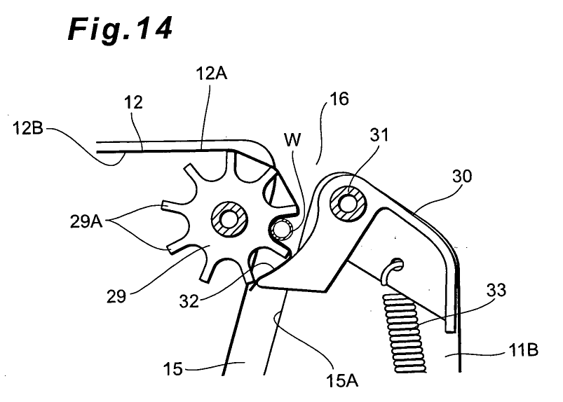

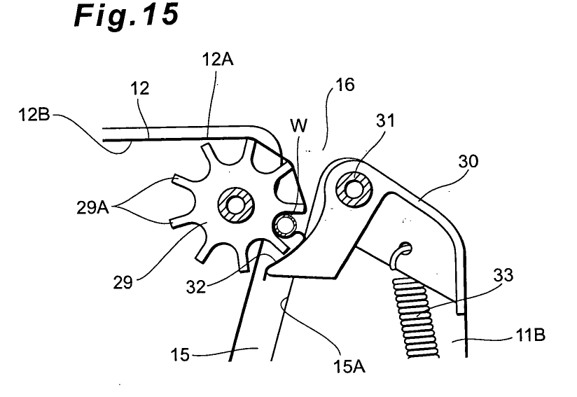

When the tape-supplying member 29 further rotates, the top end of the engaging projection 29A that comes into contact with object W comes into contact with and slides over the sliding surface 32 as shown in FIG. 14. Then as shown in FIG. 15, the preceding engaging projection 29A slides over the non-adhesive surface 12B of the adhesive tape 12 and presses it against the sliding surface 32, thereby ensuring the affixing of the adhesive tape 12 to the sliding surface 32. The preceding engaging projection 29A then moves away from the lower end of the sliding surface 32. The adhesive tape 12 adhesively attached to the sliding surface 32 is gradually peeled off, reversed, and then winds itself around the binding part of object W.

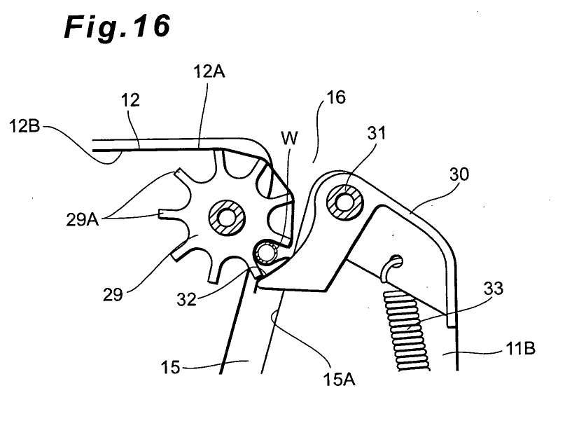

As the tape-supplying member 29 further rotates, as shown in FIG. 16, the engaging projection 29A that comes into contact with object W slides over the non-adhesive surface 12A of the adhesive tape 12 adhesively attached to the sliding surface 32 and further ensures the affixing of the adhesive tape 12 to the sliding surface 32, while the top end of the following engaging projection 29A slides on the non-adhesive surface 12B of the adhesive tape 12.

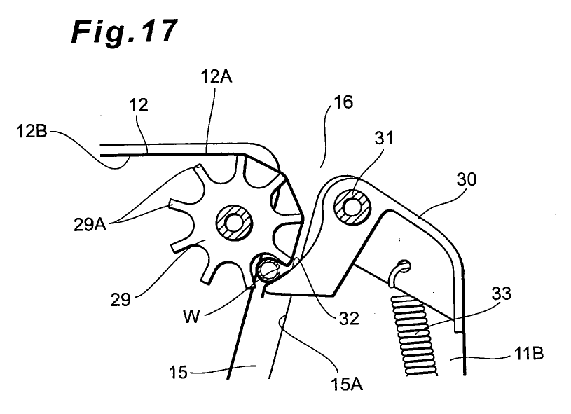

As the tape-supplying member 29 further rotates, as shown in FIG. 17, the engaging projection 29A immediately after object W comes into contact with the sliding surface 32 and presses and temporarily affixes the adhesive surface 12A of the adhesive tape 12, which is engaged with the top end of the engaging projection 29A, to the adhesive surface 12A of the adhesive tape 12 that is peeled off and reversed from the sliding surface 32. Almost at the same time, the preceding engaging projection 29A that comes into contact with object W moves away from the sliding surface 32.

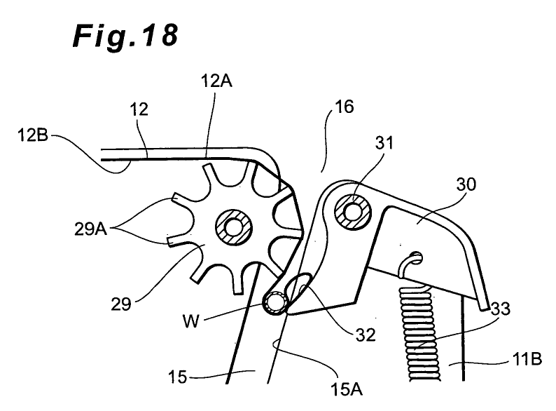

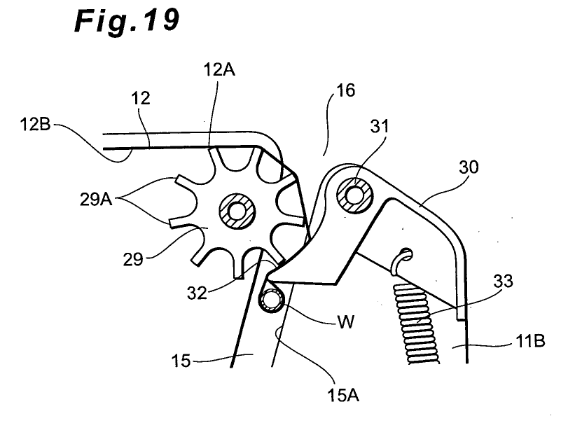

Next as shown in FIGS. 18 and 19, as the preceding engaging projection 29A moves away from the sliding surface 32, object W comes into direct contact with the lower end of the sliding surface 32 of the affixing member 30, thereby causing the affixing member 30 to rotate against the force of the coil spring 33 and causing object W to move downward away from the affixing member 30. Then, the affixing member 30 comes into contact with the engaging projections 29A again.

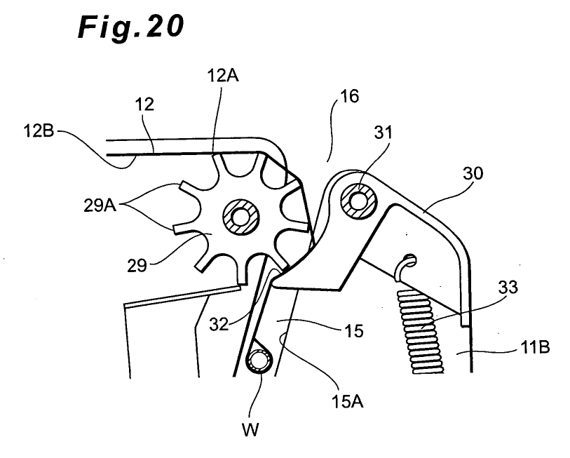

As shown in FIG. 20, when object W is moved further downward, the tape-supplying member 29, around which the adhesive-tape 12 placed, rotates together with the adhesive tape 12; and the adhesive tape 12 that has been already adhesively attached to the sliding surface 32 is peeled off and reversed, and is then attached to the adhesive surface 12A of the adhesive tape 12 that is drawn downward from the top end of the sliding surface 32, thereby pasting their adhesive surfaces 12A together. At the same time, since the adhesive tape 12 attached to the sliding surface 32 is reversed so that the two non-adhesive surfaces 12B are exposed, it is possible to pull down the adhesive tape 12 smoothly without resistance. Moreover, when the entire length of the adhesive tape 12 attached to the sliding surface 32 is peeled off and affixed to the other adhesive surface 12A and then the adhesive tape 12 is pulled down a specified length, object W pushes and rotates the tape-cutting member 34, thereby causing the cutter blade 37 to cut off the adhesive tape 12 right below the lower end of the affixing member 30.

Subsequently, the cutter 19 is used to cut off the top of object W as necessary, and object W is removed via the outlet 17.

Since the adhesive tape 12 which has the overlapping area 12C is used to bind object W, this overlapping area 12 functions as a tab that makes it easier to peel off the adhesive tape 12 and to easily remove the binding of object W. Since there is the marked line 12F near this tab (i.e. the overlapping area 12C), it is possible to easily find the tab and to conduct the binding removal process more easily.

Moreover, as described above, it is possible to automatically form the overlapping area 12C when binding object W with the adhesive tape 12.

I claim:

1. An adhesive binding tape cutter for binding an object with adhesive tape, comprising:
a tape-supporting member for supporting a wound body of adhesive tape in a rotatable manner around which a tape whose one side is an adhesive surface is wound;
a guide-path for connecting an inlet and an outlet for the object;
a tape-supplying member for guiding the adhesive tape drawn from the wound body of adhesive tape into the guide-path and for surrounding the object with the adhesive tape; and
a tape-cutting member that is located behind the tape-supplying member in the guide-path and protrudes so that the tape-cutting member can enter into the guide-path;
wherein an overlapping-area-forming mechanism for forming an overlapping area of the adhesive tape, along at least one margin in its lengthwise direction, that is made by folding under the adhesive tape in a specified width toward the adhesive surface side is placed between the tape-supporting member and the guide-path, and
wherein the overlapping-area-forming mechanism comprises:
a first support member that is located near an adhesive-tape-unwinding position of the wound body of adhesive tape and supports a non-adhesive surface of the adhesive tape;
a fold-starting member that is located downstream of the first support member, supports the adhesive surface of the adhesive tape while leaving a specified folding width along the margin of the adhesive tape, and folds the folding width area;
a main folding member that is located downstream of the fold-starting member and folds under, at an acute angle, the area of the adhesive tape folded by the fold-starting member; and
an attaching member that is located at a position opposite to the main folding member, supports the non-adhesive surface of the adhesive tape, and presses and attaches the area folded under by the main folding member to the adhesive surface of the adhesive tape.

2. The adhesive binding tape cutter according to claim 1, further comprising a second support member that is located downstream of the attaching member and supports the non-adhesive surface of the adhesive tape.

3. The adhesive binding tape cutter according to claim 1 or 2, wherein the surface of the fold-starting member has protrusions and indentations.

4. The adhesive binding tape cutter according to claim 1, wherein the first support member, the fold-starting member, and the attaching member are roller members placed in a rotatable manner so that they guide the adhesive tape from upstream to downstream.

5. The adhesive binding tape cutter according to claim 2, wherein the second support member is a roller member placed in a rotatable manner so that it guides the adhesive tape from upstream to downstream.

6. The adhesive binding tape cutter according to claim 1, wherein a controlling member for controlling the position of the adhesive tape is placed at the end of the fold-starting member on the side where the other margin of the adhesive tape is located, opposite the margin where the overlapping area of the adhesive tape is formed.

7. The adhesive binding tape cutter according to claim 6, wherein the distance between the controlling member of the fold-starting member and a contact part of the main folding member that comes into contact with the margin side of the overlapping area of the adhesive tape is shorter than the width of the adhesive tape that forms the wound body of adhesive tape.

8. The adhesive binding tape cutter according to claim 1, wherein a controlling member for controlling the position of the adhesive tape is placed at the end of the second support member on the side where the other margin of the adhesive tape is located, opposite the margin where the overlapping area of the adhesive tape is formed.

9. The adhesive binding tape cutter according to claim 8, wherein the distance between the controlling member of the second support member and a contact part of the main folding member that comes into contact with the margin side of the overlapping area of the adhesive tape is shorter than the width of the adhesive tape that forms the wound body of adhesive tape.

10. The adhesive binding tape cutter according to claim 1, wherein the main folding member has a pressing member capable of pressing only the vicinity of the area of the adhesive tape folded under by the main folding member.

11. The adhesive binding tape cutter according to claim 1, wherein the main folding member comprises:
a first folding guide member that comes into contact with the non-adhesive surface of the adhesive tape folded by the fold-starting member and guides the adhesive tape so that the fold angle of the adhesive tape becomes more acute; and
a second folding guide member for guiding the adhesive tape and folding the adhesive tape completely onto itself.

12. The adhesive binding tape cutter according to claim 1, wherein the tape-supplying member has a multiplicity of radially extending projections and can rotate in order to guide the adhesive tape from upstream to downstream,
wherein the projections are located within the guide-path and engage with the object guided into the guide-path, thereby making the tape-supplying member rotate.

13. The adhesive binding tape cutter according to claim 1, further comprising an affixing member that is located at a position opposite the top ends of the projections of the tape-supplying member and has a bent sliding surface that slides in a manner capable of moving closer to and away from the tape-supply member and comes into contact with the top ends of the projections of the tape-supplying member as it slides,
wherein the sliding surface causes affixing of a specified length of the adhesive surface of the adhesive tape.

14. The adhesive binding tape cutter according to claim 13, wherein the affixing member is provided with a force-applying member for applying force to the affixing member in order to make the affixing member press and make contact with the top ends of the projections of the tape-supplying member.

15. The adhesive binding tape cutter according to claim 1, wherein the tape-cutting member is located downstream of the tape-supplying member, is capable of rotating on the axis of its approximate center, and has force applied to its lower end so that the tape-cutting member is always located within the guide-path, and has a cutting blade at its upper end,
wherein when the object guided into the guide-path presses and causes the tape-cutting member to rotate, the cutting blade placed at the upper end of the tape-cutting member moves into the guide-path and cuts the adhesive tape.

16. An adhesive tape for the adhesive binding tape cutter according to claim 1, wherein a marked line is formed along the overlapping area in the vicinity of an area to become the overlapping area formed by the overlapping-area-forming mechanism of the adhesive binding tape cutter.

17. The adhesive tape for the adhesive binding tape cutter according to claim 16, wherein the marked line includes at least one of: marks, letters, and pictures to indicate the existence of the overlapping area.
